(19) United States
(12) Patent Application Publication
(10) Pub. No.: US 2023/0162066 A1
(43) Pub. Date: May 25, 2023

(54) MACHINE LEARNING AND STATISTICAL BASED ANOMALY DETECTION ALGORITHM TO REACT TO CORRELATION SHIFTS

(71) Applicant: Visa International Service Association, San Francisco, CA (US)

(72) Inventors: Nazmiye Ceren Abay, Foster City, CA (US); Akon Dey, Foster City, CA (US); Navendu Misra, Austin, TX (US); Durga Kala, Foster City, CA (US)

(21) Appl. No.: 17/533,985

(22) Filed: Nov. 23, 2021

(51) Int. Cl. G06N 7/00; G06N 5/00

(52) U.S. Cl. CPC G06N 7/005; G06N 5/003

(57) ABSTRACT

A method is disclosed. The method comprises generating by a processing network computer, a first attribute correlation matrix comprising correlations between attributes of a first interaction dataset, wherein the first interaction dataset comprises interaction data of a plurality of interactions conducted over a first time period. The processing network computer may generate a second attribute correlation matrix, similar to the first attribute correlation matrix, comprising interaction data conducted over a second time period. The method then comprises identifying sets of attributes from the first attribute correlation matrix and the second attribute correlation matrix. After identifying sets of attributes, the processing network computer may compute residuals between the first attribute correlation matrix and the second attribute correlation matrix. The processing network computer may then determine a number of interaction anomalies in the first interaction dataset using the residuals.

### CROSS-REFERENCES TO RELATED APPLICATIONS

None.

### BACKGROUND

The security and integrity of interaction systems is of great interest. The ability to detect abnormal behavior associated with interactions is important to maintaining the security and integrity of such interaction systems. An anomaly detection system can be used to identify interactions that deviate considerably from an expected norm.

Many anomaly detection tools are impractical to be implemented for high dimensional data, due the data size and complexity of transaction datasets. To analyze large transaction datasets, many anomaly detection tools focus on select attributes of transaction data sets, due to the complexity of transaction datasets. However, such conventional anomaly detection tools have deficiencies and can be improved.

Embodiments of the disclosure address this problem and other problems individually and collectively.

### SUMMARY

One embodiment of the invention includes a method. The method comprising: generating, by a processing network computer, a first attribute correlation matrix comprising correlations between attributes of a first interaction dataset, wherein the first interaction dataset comprises interaction data of a plurality of interactions conducted over a first time period; generating, by the processing network computer, a second attribute correlation matrix comprising correlations between attributes of a second interaction dataset, wherein the second interaction dataset comprises interaction data of a plurality of interactions conducted over a second time period; identifying, by the processing network computer, sets of attributes from the first attribute correlation matrix and the second attribute correlation matrix; computing, by the processing network computer, residuals between the first attribute correlation matrix and the second attribute correlation matrix; and determining, by the processing network computer, interaction anomalies using the residuals, wherein an interaction anomaly in the interaction anomalies corresponds to an interaction in the first interaction dataset.

Another embodiment is related to a processing network computer comprising: a processor; and a non-transitory computer readable medium comprising instructions executable by the processor to perform operations including: generating, by a processing network computer, a first attribute correlation matrix comprising correlations between attributes of a first interaction dataset, wherein the first interaction dataset comprises interaction data of a plurality of interactions conducted over a first time period; generating, by the processing network computer, a second attribute correlation matrix comprising correlations between attributes of a second interaction dataset, wherein the second interaction dataset comprises interaction data of a plurality of interactions conducted over a second time period; identifying, by the processing network computer, sets of attributes from the first attribute correlation matrix and the second attribute correlation matrix; computing, by the processing network computer, residuals between the first attribute correlation matrix and the second attribute correlation matrix; and determining, by the processing network computer, interaction anomalies using the residuals, wherein an interaction anomaly in the interaction anomalies corresponds to an interaction in the first interaction dataset.

A better understanding of the nature and advantages of embodiments of the invention may be gained with reference to the following detailed description and accompanying drawings.

### BRIEF DESCRIPTION OF THE DRAWINGS

FIG. 1 shows a block diagram of an interaction processing system.

FIGS. 2A and 2B show examples attribute correlation matrices.

FIG. 3 shows a machine learning and statistical based anomaly detection method.

FIG. 4 shows a block diagram of an exemplary processing network computer.

FIG. 5 shows a scatterplot of residuals and with overlaid effects using an Isolation Forest Algorithm.

### DETAILED DESCRIPTION

Prior to discussing embodiments of the disclosure, some terms can be described in further detail.

A “user” may include an individual. In some embodiments, a user may be associated with one or more personal accounts and/or mobile devices. The user may also be referred to as a cardholder, account holder, or consumer in some embodiments.

A “user device” may be a device that is operated by a user. Examples of user devices may include a mobile phone, a smart phone, a card, a personal digital assistant (PDA), a laptop computer, a desktop computer, a server computer, a thin-client device, a tablet PC, etc. Additionally, user devices may be any type of wearable technology device, such as a watch, earpiece, glasses, etc. The user device may include one or more processors capable of processing user input. The user device may also include one or more input sensors for receiving user input. As is known in the art, there are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. A user device may also be a credit, debit, or prepaid card.

A “resource provider” may be an entity that can provide a resource such as goods, services, information, and/or access to a location (e.g., a parking space, a transit terminal, etc.). Examples of resource providers include merchants, governmental authorities, secure data providers, etc. A resource provider may operate one or more access devices.

An “access device” may be any suitable device that provides access to a resource. An access device may be in any suitable form. Some examples of access devices include vending machines, kiosks, POS or point of sale devices (e.g., POS terminals), cellular phones, PDAs, personal computers (PCs), tablet PCs, hand-held specialized readers, set-top boxes, electronic cash registers (ECRs), automated teller machines (ATMs), virtual cash registers (VCRs), and the like. An access device may use any suitable contact or contactless mode of operation to send or receive data from, or associated with, a user mobile communication device. In some embodiments, an access device may include a reader, a processor, and a computer-readable medium. A reader may include any suitable contact or contactless mode of operation. For example, exemplary readers can include radio frequency (RF) antennas, optical scanners, bar code readers, or magnetic stripe readers to interact with a payment device and/or mobile communication device.

“Access data” may include any suitable data that can be used to access a resource or create data that can access a resource. In some embodiments, access data may be account information for a payment account. Account information may include a PAN, payment token, expiration date, card verification values (e.g., CVV, CVV2), dynamic card verification values (dCVV, dCVV2), an identifier of an issuer with which an account is held, etc. In other embodiments, access data could include data that can be used to access a location or to access secure data. Such information may be ticket information for an event, data to access a building, transit ticket information, passwords, biometrics or other credentials to access secure data, etc.

An “authorizing entity” may be an entity that authorizes a request. Examples of an authorizing entity may be an issuer, a governmental agency, a document repository, an access administrator, etc. An authorizing entity may operate an authorizing entity computer. An “issuer” may refer to a business entity (e.g., a bank) that issues and optionally maintains an account for a user. An issuer may also issue payment credentials stored on a user device, such as a cellular telephone, smart card, tablet, or laptop to the consumer.

An “authorization request message” may be a message that requests permission to conduct an interaction. For example, an authorization request message may include an electronic message that is sent to a payment processing network and/or an issuer of a payment card to request authorization for a transaction. An authorization request message according to some embodiments may comply with (International Organization of Standardization) ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction. In some embodiments, the data included in the authorization request message may be referred to as “Interaction Data.”

An “authorization response message” may be an electronic message reply to an authorization request message. In some embodiments, it may be generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g. POS equipment) that indicates approval of the transaction. The code may serve as proof of authorization. As noted above, in some embodiments, a payment processing network may generate or forward the authorization response message to the merchant.

An “interaction” may include a reciprocal action or influence. An interaction can include a communication, contact, or exchange between parties, devices, and/or entities. Example interactions include a transaction between two parties and a data exchange between two devices. In some embodiments, an interaction can include a user requesting access to secure data (e.g., a secure data interaction), a secure webpage (e.g., a secure webpage interaction), a secure location (e.g., a secure location interaction), a communication from a sender to a recipient, and the like. In other embodiments, an interaction can include a payment transaction in which two devices can interact to facilitate a payment.

An “interaction anomaly” may refer to an interaction which deviates from what is standard, normal, or expected. Examples of interaction anomalies may include fraudulent interactions (e.g., an interaction conducted by a malicious third party pretending to be a user), new interactions (e.g., an interaction conducted by a user which is significantly different from prior interactions conducted by the user), etc. The interactions may be legitimate transactions (e.g., the new interaction is conducted by the legitimate user), while being anomalies. Examples of interaction anomalies include fraudulent payment transactions, SPAM e-mails, unauthorized Website access attempts, etc.

“Interaction data” may be data associated with an interaction. For example, an interaction may be a transfer of a digital asset from one party to another party. In some embodiments, an interaction can include a transaction between a user and a resource provider. Interaction data, for example, may include a transaction amount. In some embodiments, interaction data can indicate different entities that are party to an interaction as well as value or information being exchanged. Interaction data can include an interaction amount, information associated with a sender (e.g., a token or account information, an alias, a device identifier, a contact address, etc.), information associated with a receiver (e.g., a token or account information, an alias, a device identifier, a contact address, etc.), one-time values (e.g., a random value, a nonce, a timestamp, a counter, etc.), and/or any other suitable information. An example of interaction data can be transaction data. Interaction data may also include information whether a CVM is attempted/successful, and which type of CVM was used. In some embodiments, the different data types in interaction data may be referred to as “attributes.” For example, an “attribute” may be “interaction amount,” “device identifier,” “token or account information,” “counter,” etc. The attribute may have associated values. For example, the attribute “interaction amount” may have a plurality of interaction amounts associated with the attribute, and in some embodiments, the plurality of interaction amounts may be referred to as the attribute. In another example, in the context of e-mail communications, interaction data might include a time when the communication is sent, the identity of the sender of the communication, the IP address of the sender of the communication, the content of the communication, etc. In another example, interaction data associated with an access attempt at a Website might include the IP address of the client computer attempting to gain access, the time or date of the access attempt, the frequency of access attempts, etc.

A “correlation matrix” may be a matrix is formed using correlations between two or more data types. In embodiments, a correlation matrix may store correlations between two or more attributes of interaction data. For example, a correlation coefficient (e.g., a Pearson's correlation coefficient, Spearman's rank correlation, Kendall's rank correlation coefficient, etc.) may be calculated between data of two or more attributes, and the correlation matrix may be formed using the correlation coefficients. In some embodiments, the correlation matrix may be a two-dimensional matrix, or a higher dimensional matrix.

A “processor” may refer to any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

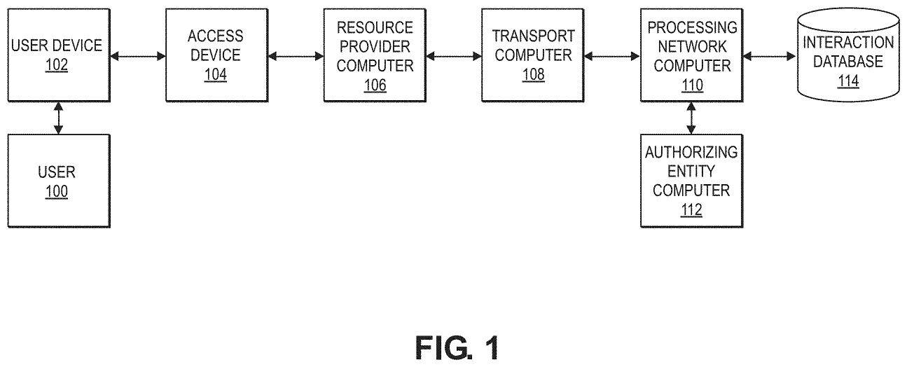

FIG. 1 shows a block diagram of an interaction processing system. FIG. 1 shows a user 100 that can operate a user device 102. The user 100 may use the user device 102 to perform an interaction with a resource provider operating a resource provider computer 106. An example interaction may be the user 100 using the user device 102 to pay for a good or service at the resource provider operating the resource provider computer 106 and/or an access device 104. The resource provider may communicate with an authorizing entity computer 112 via an transport computer 108 and a processing network computer 110. The processing network computer 110 may be comprise an interaction database 114 which stores information related to the interaction.

The processing network computer 110 may include data processing subsystems, networks, and operations used to support and deliver authorization services, exception file services, and clearing and settlement services. An exemplary processing network may be a payment processing network that which include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network may use any suitable wired or wireless network, including the Internet.

A typical payment interaction flow using a user device 102 at an access device 104 (e.g., a POS location) can be described as follows. A user 100 presents their user device 102 to an access device 104 to pay for an good and/or service. The user device 102 and the access device 104 interact such that access data from the user device 102 (e.g., PAN, a payment token, verification value(s), expiration date, etc.) is received by the access device 104 (e.g., via a contact or contactless interface). The resource provider computer 106 may then receive this information from the access device 104 via an external communication interface. The resource provider computer 106 may then generate an authorization request message that includes the information received from the access device 104 (i.e. information corresponding to the user device 102) along with additional transaction information (e.g., an interaction amount or a transaction amount, merchant specific information such as location or name, etc.) and electronically transmits this information to an transport computer 108. The transport computer 108 may then receive, process, and forward the authorization request message to a processing network computer 110 for authorization.

In general, prior to the occurrence of a credit or debit-card transaction, the processing network computer 110 has an established protocol with each authorizing entity on how the authorizing entity's transactions are to be authorized. In some cases, such as when the transaction amount is below a threshold value, the processing network computer 110 may be configured to authorize the transaction based on information that it has about the user's account without generating and transmitting an authorization request message to the authorizing entity computer 112. In other cases, such as when the transaction amount is above a threshold value, the processing network computer 110 may receive the authorization request message, determine the authorizing entity associated with the user device 102, and forward the authorization request message for the transaction to the authorizing entity computer 112 for verification and authorization. Once the transaction is authorized, the authorizing entity computer 112 may generate an authorization response message (that may include an authorization code indicating the transaction is approved or declined) and transmit this electronic message via its external communication interface to processing network computer 110. The processing network computer 110 may then forward the authorization response message to the transport computer 108, which in turn may then transmit the electronic message to comprising the authorization indication to the resource provider computer 106, and then to the access device 104. The processing network computer 110 may additionally store interaction data (e.g., interaction data for one transaction may comprise all data in the authorization request message) for the payment interaction in the interaction database 114.

At the end of the day or at some other suitable time interval, a clearing and settlement process between the resource provider computer 106, the transport computer 108, the processing network computer 110, and the authorizing entity computer 112 may be performed on the transaction.

The processing network computer 110 may store data for a large amount of interactions performed by a variety of users. The interaction data may comprise a number of attributes. When the interaction is a transaction, examples of attributes may include “transaction amount (tran_amt),” “declined transaction amount (declined_tran_amt),” “transaction count (tran_cnt),” “declined transaction count (declined_tran_cnt),” “authorization code (apprvl_dc),” “merchant category code (mrch_catgy_cd),” “card present/not present (cp_cnp),” “merchant location,” etc.

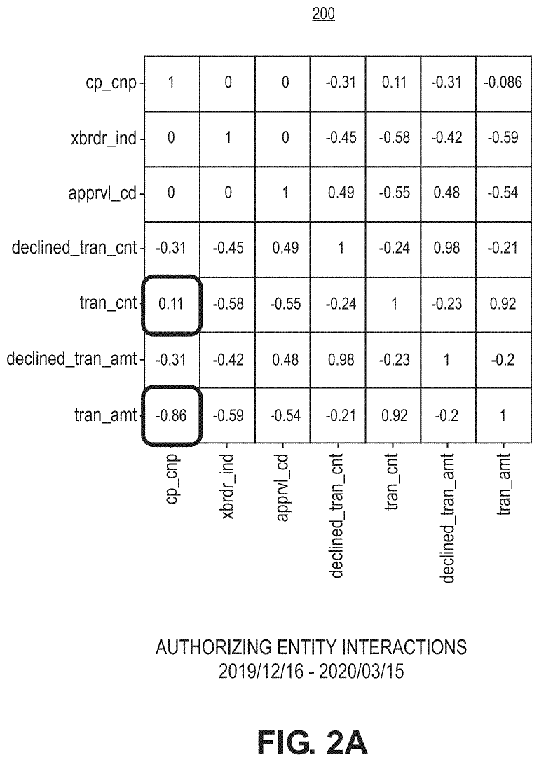

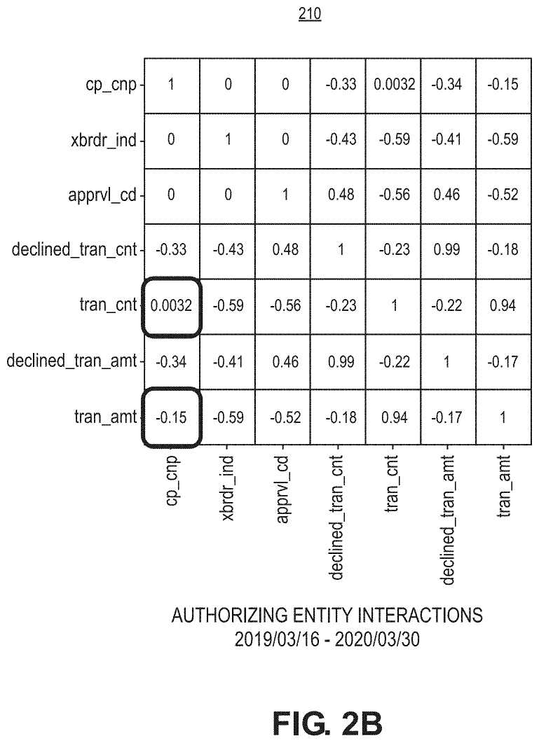

FIGS. 2A and 2B show two examples of two-dimensional attribute correlation matrices generated using interaction data. The interaction data may be transaction data such as credit or debit card transaction data. A first attribute correlation matrix 200 may correspond to a first interaction dataset associated with a first time period (e.g., transactions that occurred in a first three month period). A second attribute correlation matrix 210 may correspond to a second interaction dataset associated with a second time period (e.g., transactions that occurred in a second three month period that is later than the first three month period). Although two two-dimensional correlation matrices are illustrated, it is understood that the matrices according to embodiments of the invention can have more than two dimensions, and there can be more than two matrices covering more than two different time periods. Note that any suitable time period can be associated with each matrix. For example, the time period for one matrix can be associated with interactions occurring within a single day, a week, a month, a year, etc.

The first attribute correlation matrix 200 can have the following attributes on the y-axis, starting from the bottom and moving up: “transaction amount (tran_amt),” “declined transaction amount (declined_tran_amt),” “transaction count (tran_cnt),” “declined transaction count (declined_tran_cnt),” “authorization code (apprvl_cd),” “cross-border transaction indicator (xbrdr_ind),” “card present/not present (cp_cnp),” “merchant location,” etc. The same attributes are listed on the x-axis starting from the right and moving to the left.

Two attributes in the first interaction dataset (or second interaction dataset) may be correlated, and the degree of correlation can be quantified by the numerical value in the box that intersects two attributes. For example, when interactions are transactions, the attribute “transaction amount (tran_amt)” may be correlated with the attribute “card present/not present (cp_cnp)”. A “card present/not present (cp_cnp)” attribute can be a transaction conducted using a payment card (or other payment device) that is physically present at a merchant vs. a transaction such as an e-commerce transaction where a payment card is not physically present at the merchant. The transactions from the first interaction dataset, which has data of the selected attributes, may thus be used to calculate the correlation between the two attributes.

In embodiments of the invention, a measure of correlation may vary between −1 (e.g., a negative correlation) and 1 (e.g., a positive correlation). A correlation coefficient close to 0 (either positive or negative) for two attributes, implies little or no relationship exists between the two attributes. For example, the attributes transaction amount (tran_amt) and card present/not present (cp_cnp) has a correlation coefficient of −0.086, which is close to zero. This suggests that these two attributes are not highly correlated (e.g., an increase in transaction amount does not suggest that users perform more card present or card not present types of transactions). A correlation coefficient close to 1 means a positive relationship between the two variables, with increases in one of the variables being associated with increases in the other variable. For example, the attribute transaction amount (tran_amt) may have a correlation value of 0.92 with the attribute transaction count (tran_cnt). The latter attribute represents the number of transactions conducted using a particular payment card (e.g., a value of 25 for this attribute would indicate that the cardholder has used a particular card 25 times during the time period). This suggests that cardholders that use a particular card more often tend to spend more on individual transactions. A correlation coefficient close to −1 indicates a negative relationship between two variables, with an increase in one of the variables being associated with a decrease in the other variable. For example, the attribute transaction amount (tran_amt) and the attribute authorization code (apprvl_cd) has a correlation coefficient of −0.54. The latter attributes indicates that a transaction is approved. The correlation coefficient of −0.54 suggests that as transaction values increase, the likelihood of approval decreases.

A correlation coefficient can be produced for ordinal, interval or ratio level variables, but has little meaning for variables which are measured on a scale which is no more than nominal. For ordinal scales, the correlation coefficient can be calculated by using Spearman's rho. For interval or ratio level scales, the most commonly used correlation coefficient is Pearson's r, ordinarily referred to as simply the correlation coefficient. In a two-dimensional example (e.g., two attributes are selected to be correlated), Pearson's correlation coefficient, r, for a sample may be calculated using the following equation:

$$r = \frac{Σ ( {x}_{i} - \overline{x} ) ( {y}_{i} - \overline{y} )}{\sqrt{{Σ ( {x}_{i} - \overline{x} )}^{2} {Σ ( {y}_{i} - \overline{y} )}^{2}}}$$

Where xᵢ is a value of a first attribute (e.g., a transaction amount from the first interaction dataset), x̅ is the mean value of the first attribute (e.g., the mean transaction amount from the first interaction dataset), yᵢ is a value of a second attribute (e.g., a value of card present/not present from the first interaction dataset), and y̅ is the mean value of the second attribute (e.g., the mean value of card present/not present). The Pearson's correlation coefficient, r, may then be included in the attribute correlation matrix. Further details of correlation coefficients can be found in Patrick Shober, et. al., “Correlation Coefficients: Appropriate Use and Interpretation,” Anesthesia & Analgesia: May 2018—Vol. 126—Issue 5, pp. 1763-1768.

The first attribute correlation matrix 200 shows correlations between various attributes, using interaction data of the first interaction dataset. The second attribute correlation matrix 210 shows correlations between the same various attributes, using interaction data of the second interaction dataset.

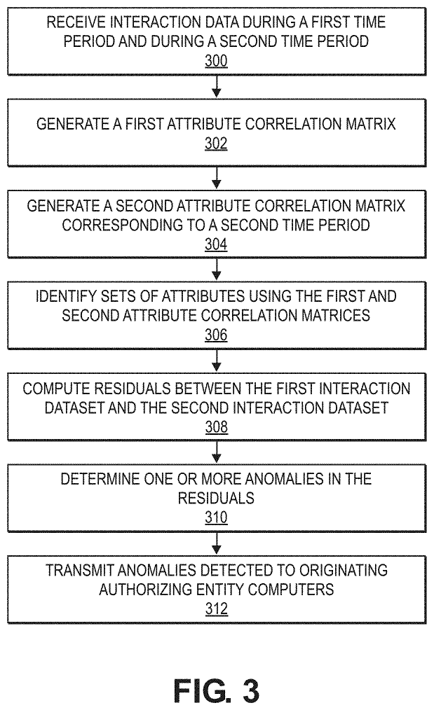

FIG. 3 shows a machine learning and statistical based anomaly detection method. The method described by FIG. 3 may be performed by a processing network computer 110, as shown in FIG. 1.

At block 300, the processing network computer may receive interaction data during a first time period and during a second time period. The first second time period can be after the first time period. For example, the first time period can be a three month time period and the second time period can be another three month time period after the first three month time period. The interaction data can be transaction data such as credit or debit card transaction data, demand account transaction data (e.g., checking account transaction data), access transaction data (e.g., computer logins) etc.

At block 302, the processing network computer may generate a first attribute correlation matrix. The processing network computer may compute correlation values for all combinations of two attributes in the first interaction dataset. The first attribute correlation matrix may be associated with a first time period, in which the interactions of the first interaction dataset were conducted. The correlation values may be aggregated to form the first attribute correlation matrix, which may have a similar form to the first attribute correlation matrix 200 shown in FIG. 2A.

At block 304, the processing network computer may generate a second attribute correlation matrix. The second attribute correlation matrix may be stored in memory by the processing network computer, or in the interaction database which stores interaction dataset. The second attribute correlation matrix may be computed in a similar to the first attribute correlation matrix, using a second interaction dataset comprising interactions conducted over a second time period. An example of a second attribute correlation matrix 210 is shown in FIG. 2B.

At block 306, the processing network computer may identify sets of attributes (e.g., pairs of attributes if the attribute correlation matrices are two-dimensional matrices, etc.) to be used in further processing. The sets of attributes can be identified using the first attribute correlation matrix and the second attribute correlation matrix. In some embodiments, the processing network computer may determine one or more sets of attributes that have one or more significant differences in correlation coefficients between the first attribute correlation matrix and the second attribute correlation matrix (or vice-versa). For example, the processing network computer may select one or more sets of attributes that have the highest difference in correlation coefficients between the two attribute correlation matrices, or sets of attributes that have a difference in correlation coefficient above a threshold value. A significant difference can be, for example, a significant increase or decrease in a correlation coefficient in one time period vs. another. The relative percent change could be, for example, at least about 30, 40, 50, 60, 70 percent, etc. For example, with reference to FIGS. 2A and 2B, a first set of attributes that can be identified can include a “transaction count (tran_cnt)” and “card present/not present (cp_cnp),” because the difference between the correlation coefficients in the first and second time periods is significant (i.e., 0.11 to 0.0032, which is approximately a 97 percent relative change ((0.11+0.0032)/0.11). A second set of attributes that can be identified can include a “transaction amount (tran_amt)” and “card present/not present (cp_cnp),” because the difference between the correlation coefficients in the first and second time periods is significant (i.e., −0.086 to −0.15, which is approximately a 74 percent relative change).

In this example, the data used to form the first matrix 200 and the second matrix 210 in FIGS. 2A and 2B can be respectively derived from interaction data before the COVID pandemic started and after the COVID pandemic started. In this example, the time that the COVID pandemic approximately started forms the start of the second time period, and the day before that COVID pandemic start date forms the end of the first time period. Referring to FIGS. 2A and 2B, the correlation coefficient between “transaction count (tran_cnt)” and “card present/not present (cp_cnp)” can be 0.11 in the first matrix 200 and 0.0032 in the second matrix 210. Because the number of e-commerce transactions significantly increased during the COVID pandemic and likely constituted a majority of the transaction conducted, the attribute “card present/not present (cp_cnp)” and the attribute “transaction count (tran_cnt)” since a greater number of transactions of different types were conducted as e-commerce transactions.

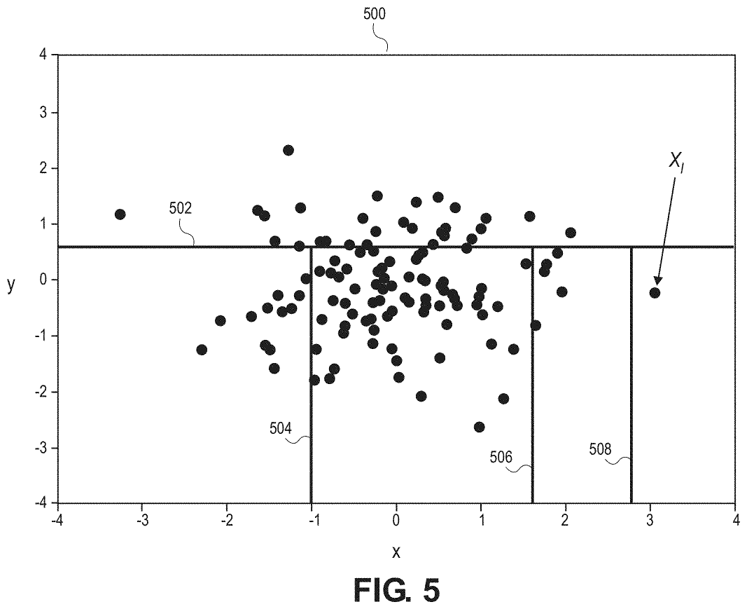

At block 308, after determining one or more sets of attributes to be further processed, the processing network computer may compute residuals between the interaction data corresponding to the one or more sets of attributes in the first interaction dataset and the second interaction dataset. A model (e.g., a regression line) could be formed from the interaction data in the first interaction dataset, and an analysis can be conducted to determine how each of the interaction data (e.g., transaction data) for each interaction compares to the model formed by the first interaction dataset. For example, the first interaction dataset may include four transactions: Transaction 1 (card present, $50), transaction 2 (card not present, $75), transaction 3 (card not present, $25), transaction 4 (card present $100), and a model can be formed to determine the relationship between the attributes between “transaction amount (tran_amt)” and “card present/not present (cp_cnp)”. The second interaction dataset may include: Transaction 5 (card not present, $40), transaction 6 (card not present, $35), transaction 7 (card not present, $50), and transaction 8 (card not present $60). Residuals can be calculated to determine how well each of transactions 5-8 correlate to the model. In a two-dimensional example, the residuals may be visualized as a scatterplot, with the two attributes on the axes of the scatterplot, and the residuals may form points in the scatterplot. FIG. 5 shows an exemplary scatterplot of points of residuals of two dimensions.

At block 310, after computing residuals, the processing network computer may determine anomalies in the residuals. In some embodiments, the processing network computer may apply an Isolation Forest algorithm to determine the anomalies. The Isolation Forest algorithm is a supervised, machine learning based anomaly detection algorithm that assigns an anomaly score to nodes (e.g., points in the residuals) according to the tree depth obtained by recursively splitting the set of nodes of a dataset at random based on picking a random value within the observed range from a random column at each time, until a node is isolated in a tree branch. Rarer observations will need fewer splits to become isolated. The Isolation Forest algorithm is a time and space efficient algorithm, and is good at handling high dimensional data (e.g., the transaction data in the interaction datasets) with low memory usage. Further details of the Isolation Forest algorithm may be found in Fei Tony Liu, et al., “Isolation Forest,” ICDM '08: Proceedings of the 2008 Eighth IEEE International Conference on Data Mining, IEEE Computer Society pp. 413-422.

A visualization of the Isolation Forest algorithm can be found in the description of FIG. 5. FIG. 5 shows a scatterplot 500 of residuals and overlaid Isolation Forest Algorithm. The scatterplot 500 may comprise residuals of attributes. The

Isolation Forest algorithm may detect anomalies points in the residuals by isolating points using residual portioning, where more anomalous points require less random partitions to be isolated. For example, a first partition 502 may be randomly selected (e.g., a random value on the y-axis), which splits the scatterplot. After the first partition 502 has been selected, a second partition 504 may be randomly selected (e.g., a random value on the x-axis) that splits the remaining residual points. After the second partition 504 has been selected, a third partition 506 may be randomly selected (e.g., a random value on the x-axis above x=−1) that splits the remaining residual points. After the third partition 506 has been selected, a fourth partition 508 may be randomly selected (e.g., a random value on the x-axis above x=2.9) that splits the remaining residual points. An residual point X₁ may be isolated, and may be selected to be anomalous based on the amount of partitions that were required to isolated the point (e.g. four total partitions).

The Isolation Forest algorithm may result in a number of nodes, corresponding to interactions in the first interaction dataset, that are anomalous. If the interactions are transactions, the anomalous nodes may correspond to fraudulent transactions. The processing network computer may then store the anomalies, and the sets of attributes that were used to determine the anomalies.

At block 310, after determining anomalous interactions, for each anomalous interaction, the processing network computer may transmit a message comprising the sets of attributes used to determine the anomalies and an identifier for the interaction corresponding to the anomalies that were determined to the originating authorizing entity computer. For example, if four interactions were determined to be anomalies, first and second interaction data may have been received from a first authorizing entity computer, third interaction data may have been received from a second authorizing entity computer, and fourth interaction data may have been received from a third authorizing entity computer. The processing network computer may then transmit a first message that comprises the first and second interaction to the first authorizing entity computer, etc. The authorizing entity computer may then communicate with the user device which performed the interaction to further investigate the anomaly. For example, the authorizing entity computer may transmit a message to the user device which comprises transaction data corresponding to the anomalous transaction. The user device may respond to the authorizing entity computer, confirming or denying that the transaction was fraudulent or not. The authorizing entity computer may further transmit the result received from the user device to the processing network computer, so that the processing network computer may evaluate the quality of the anomaly detection (e.g., how many anomalies detected were fraudulent transactions).

Embodiments provide for a number of advantages. Traditional anomaly detection methods are not suited to handle high dimensional datasets. Many interaction processing systems, such as those similar to the system described in FIG. 1, collect data on a wide number of attributes of interactions, resulting in high dimensional datasets. To counteract this, prior anomaly detection methods have a pre-established set of attributes that are used to detect anomalies. Embodiments of the invention allow the processing network computer to use any combination of attributes of the interaction data to detect anomalies. Embodiments of the invention are more efficient at detecting anomalies in interaction datasets. Additionally, the combination of attributes may also be used to detect anomalies in future interaction datasets, or by authorizing entities to reject future interactions. For example, if the same combination of attributes results in a large number of anomalies detected, the combination of attributes may be transmitted to authorizing entity computers. When receiving future authorization request messages for interactions, the authorizing entity computer may more closely look at the combination of attributes in interaction data before authorizing the interaction.

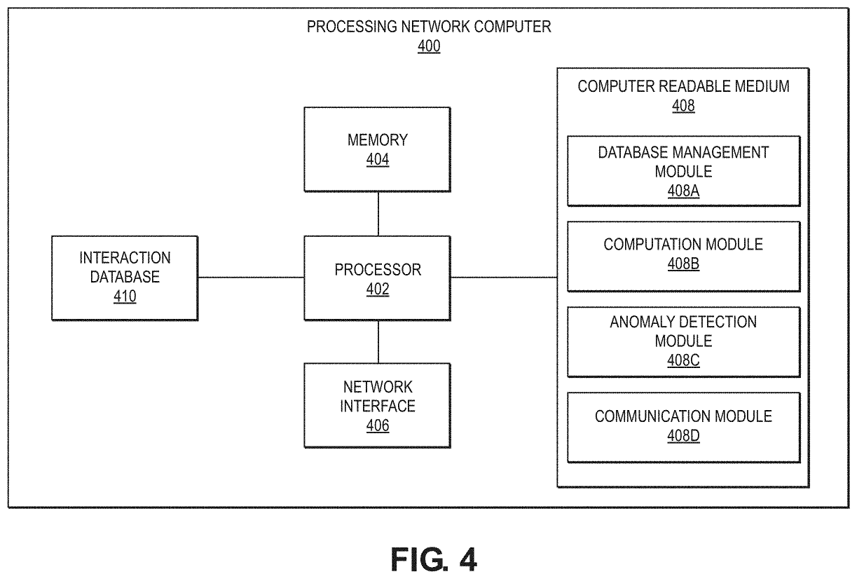

FIG. 4 shows a block diagram of an exemplary processing network computer 400. The processing network computer 400 may be operated by a processing network such as a payment processing network. The processing network computer 400 may comprise a processing 402. The processor 402 may be coupled to a memory 404, a network interface 406, a computer readable medium 408, and an interaction database 410. The computer readable medium 408 may comprise any suitable number and types of software modules.

The memory 404 may be used to store data and code. The memory 404 may be coupled to the processor 402 internally or externally (e.g., via cloud based data storage), and may comprise any combination of volatile and/or non-volatile memory such as RAM, DRAM, ROM, flash, or any other suitable memory device

The network interface 406 may include an interface that can allow the processing network computer 400 to communicate with external computers and/or devices. The network interface 406 may enable the processing network computer 400 to communicate data to and from another device such as transport computers or authorizing entity computers. Some examples of the network interface 406 may include a modem, a physical network interface (such as an Ethernet card or other Network

Interface Card (NIC)), a virtual network interface, a communications port, a Personal Computer Memory Card International Association (PCMCIA) slot and card, or the like. The wireless protocols enabled by the network interface 406 may include Wi-Fi. Data transferred via the network interface 406 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 406 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

The computer readable medium 408 may comprise a number of software modules including, but not limited to, a database management module 408A, a computation module 408B, an anomaly detection module 408C, and a communication module 408D.

The computer readable medium 408 may comprise code, executable by the processor 402, for a method comprising: generating, by a processing network computer, a first attribute correlation matrix comprising correlations between attributes of a first interaction dataset, wherein the first interaction dataset comprises interaction data of a plurality of interactions conducted over a first time period; retrieving, by the processing network computer, a second attribute correlation matrix comprising correlations between attributes of a second interaction dataset, wherein the second interaction dataset comprises interaction data of a plurality of interactions conducted over a second time period; identifying, by the processing network computer, sets of attributes from the first attribute correlation matrix and the second attribute correlation matrix; computing, by the processing network computer, residuals between the first attribute correlation matrix and the second attribute correlation matrix; and determining, by the processing network computer, interaction anomalies using the residuals, wherein an interaction anomaly in the interaction anomalies corresponds to an interaction in the first interaction dataset.

The database management module 408A may comprise code that causes the processor 402 to modify data stored in the interaction database 410. In some embodiments, the database management module 408A may receive interaction data from external devices, such as transport computers. The database management module 408A may store all interaction data received during a time period in the interaction database 410 to form an interaction dataset.

The computation module 408B may comprise code that causes the processor 402 to perform computations. For example, the computation module 408B may be used to perform an Isolation Forest algorithm. In other examples, the computation module 408B may be used to compute residuals of interaction datasets.

The anomaly detection module 408C may comprise code that causes the processing 402 to detect anomalies. The anomaly detection module 408C may communicate with the computation module 408B to determine anomalies in an interaction dataset. For example, the anomaly detection module 408C may cause the computation module 408B to perform an Isolation Forest algorithm

The communication module 408D, in conjunction with the processor 402, can generate messages, forward messages, reformat messages, and/or otherwise communicate with other entities. For example, communication module 408C can be used to facilitate communications between the processing network computer 400 and an authorizing entity computer or transport computers.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents. For example, although payment transactions are used as the underlying data used to form the correlation matrices, the interaction data is not limited to financial transactions. The interaction data can relate to interaction attempts or interactions with different host systems, interactions between computers in a computer network, e-mails or other communications (for purposes of identifying SPAM e-mails, or any other data in which anomalous behavior is to be identified.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
generating, by a processing network computer, a first attribute correlation matrix comprising correlations between attributes of a first interaction dataset, wherein the first interaction dataset comprises interaction data of a plurality of interactions conducted over a first time period;
generating, by the processing network computer, a second attribute correlation matrix comprising correlations between attributes of a second interaction dataset, wherein the second interaction dataset comprises interaction data of a plurality of interactions conducted over a second time period;
identifying, by the processing network computer, sets of attributes from the first attribute correlation matrix and the second attribute correlation matrix;
computing, by the processing network computer, residuals between the first attribute correlation matrix and the second attribute correlation matrix; and
determining, by the processing network computer, interaction anomalies using the residuals, wherein an interaction anomaly in the interaction anomalies corresponds to an interaction in the first interaction dataset.

2. The method of claim 1, further comprising:
transmitting, by the processing network computer to an authorizing entity computer, a message comprising the sets of attributes used to determine the anomalies and an identifier for the interaction corresponding to the anomalies that were determined.

3. The method of claim 1, wherein determining anomalies in the residuals comprises applying an isolation forest algorithm to the residuals.

4. The method of claim 1, wherein the interaction data in the first interaction dataset and the second interaction dataset is received from a plurality of authorizing entity computers.

5. The method of claim 1, further comprising:
storing, by the processing network computer, the anomalies and the sets of attributes.

6. The method of claim 1, wherein the first interaction dataset and the second interaction dataset comprises data regarding access to host sites by various user devices.

7. The method of claim 1, wherein the interaction data comprises at least an interaction amount.

8. The method of claim 1, wherein the plurality of interactions are performed by users in association with an authorizing entity computer.

9. The method of claim 1, wherein the first time period and the second time period are each at least one month.

10. The method of claim 1, wherein each set of attributes in the sets of attributes includes exactly two attributes.

11. The method of claim 1, wherein the correlations are correlation coefficients.

12. The method of claim 1, wherein the correlations are correlation coefficients, and wherein the correlation coefficients are determined using Spearman's rho or Pearson's r.

13. The method of claim 1, wherein the second attribute correlation set is determined in the same manner that the first attribute correlation set is determined.

14. The method of claim 1, wherein the processing network computer is operated by a processing network.

15. A processing network computer comprising:
a processor; and
a non-transitory computer readable medium comprising instructions executable by the processor to perform operations including:
generating, by a processing network computer, a first attribute correlation matrix comprising correlations between attributes of a first interaction dataset, wherein the first interaction dataset comprises interaction data of a plurality of interactions conducted over a first time period;
generating, by the processing network computer, a second attribute correlation matrix comprising correlations between attributes of a second interaction dataset, wherein the second interaction dataset comprises interaction data of a plurality of interactions conducted over a second time period;
identifying, by the processing network computer, sets of attributes from the first attribute correlation matrix and the second attribute correlation matrix;
computing, by the processing network computer, residuals between the first attribute correlation matrix and the second attribute correlation matrix; and
determining, by the processing network computer, interaction anomalies using the residuals, wherein an interaction anomaly in the interaction anomalies corresponds to an interaction in the first interaction dataset.

16. The processing network computer of claim 15, wherein further comprising an interaction database coupled to the processor, wherein the interaction database stores the first interaction dataset, the first attribute correlation set, the second interaction dataset, and the second attribute correlation set.

17. The processing network computer of claim 15, wherein in the operations, the processing network computer determines the anomalies using an isolation forest algorithm.

18. The processing network computer of claim 15, wherein the first interaction data set and the second interaction dataset are formed using data from a plurality of authorization request messages.

19. The processing network computer of claim 15, wherein the interactions in the first and second interaction datasets are performed by the user operating the user device in and authorized by the authorizing entity computer.

20. The processing network computer of claim 15, wherein the first and second interaction datasets include data associated with e-mail communications, and the interaction anomalies are SPAM e-mails.
